(19) United States
(12) Patent Application Publication
(10) Pub. No.: US 2005/0272541 A1
(43) Pub. Date: Dec. 8, 2005

(54) Chain guide for the front derailleur of a bicycle

(75) Inventors: Maurizio Valle, Vicenza (IT); Paolo Pasqua, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo, S.r.l., Vicenza (IT)

(21) Appl. No.: 11/133,076

(22) Filed: May 19, 2005

(30) Foreign Application Priority Data
Jun. 4, 2004 (EP) 04425413.4

(51) Int. Cl. F16H 9/00

(52) U.S. Cl. 474/80; 474/82

(57) ABSTRACT

A chain guide for the front derailleur of a bicycle has a first plate intended to shift a chain from a first toothed crown with a diameter to a second toothed crown with a larger diameter, a second plate facing the first plate and intended to shift the chain from the second toothed crown to the first toothed crown and a connection between the first plate and the second plate. The first plate has a first thrusting portion for shifting the chain from the first toothed crown to the second toothed crown. The first thrusting portion is defined on a projection that is defined at a first portion of the first plate and has a lower profile that projects with respect to the lower profile of the remaining portion of the first plate. It is thus possible to minimize the size of the other portions of the first plate, thus achieving a weight reduction of the chain guide, without altering its performance or reducing its structural strength.

### FIELD OF INVENTION

The present invention relates to a chain guide for the front derailleur of a bicycle, i.e. a device capable of determining and guiding the shifting of a chain from one toothed crown of a group of toothed crowns of a bottom bracket of a bicycle to another toothed crown having a different diameter, thus carrying out the gearshifting.

The invention also refers to a front derailleur comprising such a chain guide and to a plate for such a chain guide.

### BACKGROUND

As known, a front derailleur of a bicycle comprises a chain guide (or cage) and a positioning mechanism of the chain guide above the chain. Typically, the positioning mechanism of the chain guide is an articulated parallelogram mechanism, which is fixed to the frame of the bicycle at the seat tube. The chain guide can be associated with the positioning mechanism or can constitute an integral part thereof. The movement of the positioning mechanism is usually determined through mechanical or electromechanical actuators that respond to the cyclist's command. Such a movement causes the displacement of the chain guide with respect to the toothed crowns of the crankset connected to the bottom bracket of the bicycle and, consequently, the gearshifting.

With reference to the operating configuration when mounted on a bicycle, the chain guide essentially comprises a first plate or inner plate, which, with respect to the chain, lies on the side of the bicycle frame, a second plate or outer plate, which, with respect to the chain, lies on the opposite side to the first plate and connecting means between said inner and outer plates. The inner and outer plates face each other and are substantially parallel.

The inner plate acts by thrusting the chain to shift it from a crown with a smaller diameter to one with a larger diameter (upward gearshifting) and the outer plate acts by thrusting the chain to shift it from a crown with a larger diameter to one with a smaller diameter (downward gearshifting). In particular, the inner plate guides the shifting of the chain from the crown with a smaller diameter to the one with a larger diameter ensuring a continuous thrusting action on the chain against the front surface of the crown with a larger diameter; the inner plate thus typically has a surface extension larger than that of the outer plate, which, on the other hand, simply thrusts the chain away from the crown with a larger diameter to let it fall upon the crown with a smaller diameter.

One known derailleur essentially comprises a positioning mechanism of the chain guide consisting of an articulated quadrilateral comprising a fixed member integral with the frame of the bicycle and two connecting members between fixed member and chain guide which are articulated with respect to each other through pins. With reference to its mounted position on the bicycle, the chain guide comprises an inner plate and an outer plate joined at the top by a connecting plate and, at respective end portions, by a fastening screw. The inner plate extends downwards more than the outer plate. The lower profiles of the outer plate and of the inner plate both have a progression which is substantially circular and coaxial with respect to the centre of rotation of the toothed crowns.

Another known derailleur comprises a quadrilateral positioning mechanism associated with a chain guide comprising an inner plate and an outer plate. Also in this case the inner plate extends downwards more than the outer plate and the lower profiles of the plates both have a progression which is substantially circular and coaxial with respect to the centre of rotation of the toothed crowns. On the inner plate a first thrusting portion, defined on a lower plate portion and active for shifting the chain from a first toothed crown to a second toothed crown with a larger diameter, and a second thrusting portion, defined on an upper plate portion and active for shifting the chain from the second toothed crown to a third toothed crown with an even larger diameter, are defined. In a different embodiment of this known derailleur, the chain guide also comprises a chain contact portion, realized at a free end of the inner plate, which helps to prevent the falling of the chain over the first crown when the chain is shifted from the third crown to the second crown. Such a contact portion extends downwards, i.e. towards the rotation axis of the crowns, beyond the circumference defined by the ideal extension of the lower thrusting portion.

Yet another known derailleur comprises, in particular, a chain guide having an inner plate in which parts swollen towards the outer plate alternate with not-swollen parts. Also in this case, the inner plate extends downwards more than the outer plate.

In known chain guides, the need to provide an inner plate with greater extension with respect to that of the outer plate inevitably contributes to increase the overall weight of the chain guide.

### SUMMARY

A constant demand upon manufacturers of bicycles and/or bicycle components, especially of racing bicycles, is that of reducing as much as possible the overall weight of the bicycle and, therefore, of the various components of the bicycle. In accordance with such a demand, the Applicant provides a chain guide for the front derailleur of a bicycle having a reduced weight with respect to chain guides of the prior art, whilst still retaining the same functional characteristics.

According to a first aspect thereof, the present invention therefore relates to a chain guide for the front derailleur of a bicycle, comprising:

a first plate for shifting a chain from a first toothed crown with a diameter to a second toothed crown with a larger diameter;

a second plate facing said first plate for shifting said chain from said second toothed crown to said first toothed crown; and

connecting means between said first plate and said second plate;

wherein said first plate comprises a first thrusting portion for shifting said chain from said first toothed crown to said second toothed crown, wherein said first thrusting portion is defined on a projection that is defined at a first portion of said first plate and has a lower profile that projects with respect to the lower profile of the remaining portion of said first plate.

### BRIEF DESCRIPTION OF THE DRAWING(S)

Further characteristics and advantages of the present invention shall become clearer from the following description of some preferred embodiments thereof, made hereafter, for indicating and not limiting purposes, with reference to the attached drawings. In such drawings:

FIG. 1 is a schematic front view of a chain guide for a front derailleur of a bicycle and of the corresponding derailleur according to a first preferred embodiment of the invention, in the operating configuration mounted on a bicycle;

FIG. 2 is a front view of the chain guide of FIG. 1;

FIG. 3 is a top view of the chain guide of FIG. 1;

FIG. 4 is a side view of the chain guide of FIG. 1;

FIG. 5 is a front view of a plate of the chain guide of FIG. 1;

FIG. 6 is a bottom view of the plate of FIG. 5;

FIG. 7 is a top view of the plate of FIG. 5;

FIG. 8 is a side view of the plate of FIG. 5;

FIG. 9 is a section view along the line A-A of FIG. 5;

FIG. 10 is a front view of a plate of the chain guide of FIG. 1 according to a second preferred embodiment of the invention;

FIG. 11 is a section view along the line B-B of FIG. 10.

### DETAILED DESCRIPTION OF THE PREFERRED EMBODIMENT(S)

### Introduction to the Embodiments

Throughout the present description and the subsequent claims, the terms “lower” or “upper” should be interpreted with reference to the operating configuration of the chain guide mounted on the bicycle. The first plate shall hereafter also be interchangeably indicated with the term: inner plate, since, in the operating configuration of the chain guide mounted on the bicycle, it lies in an inner position with respect to the chain (closer to the bicycle frame); in the same way, the second plate shall also be interchangeably indicated with the term: outer plate, since, in the operating configuration of the chain guide mounted on the bicycle, it lies in an outer position with respect to the chain (from the side of the toothed crown with a larger diameter).

Advantageously, the localizing the first thrusting portion on a projection defined at a first portion of the first plate and projecting at the bottom with respect to the other plate portions allows the size of the other portions of said first plate to be minimized, thus achieving the desired reduction in weight of such a plate and, consequently, of the chain guide as a whole, without altering its performance or reducing its structural resistance.

Preferably, the projection is defined at an intermediate zone of said first plate. Even more preferably, the projection is defined at a zone substantially equidistant from opposite first and second free end portions of said first plate.

In this way, in the operating configuration of the chain guide when mounted on the bicycle, the first thrusting portion is advantageously in an optimal position for carrying out its thrusting action on the chain during upward gearshifting and for guiding the chain over the teeth of the crown with a smaller diameter during downward gearshifting.

Preferably, the projection extends, in a longitudinal direction of the first plate, over a portion of the first plate not larger than one third of a longitudinal size of said first plate.

Preferably, the projection comprises a first swelling that extends towards said second plate. Advantageously, such a swelling allows the first thrusting portion to come into contact with the chain in the first phases of upward gearshifting to thrust it against the front surface of the toothed crown with a larger diameter, without the chain coming into contact with the other portions of the first plate, an event that could make the action of the chain guide less efficient and cause disturbing noises during gearshifting.

In a preferred embodiment of the present invention, the projection is integrally formed with the first plate and can therefore advantageously be manufactured together with it in a single manufacturing process, e.g. by molding, plastic deformation from a sheet, casting or die casting.

In an alternative embodiment, the projection is defined on an element removably associated with the first plate. This solution allows an inner plate of a standard chain guide (for example a chain guide used for double cranksets with two toothed crowns) to be adapted to different operating demands that require first thrusting portions of different shape and/or size and more or less projecting.

Preferably, said first plate comprises a second thrusting portion for shifting said chain from said at least one first toothed crown to said at least one second toothed crown, wherein said second thrusting portion is defined at a zone of the remaining portion of the first plate arranged above said first portion. More preferably, said second thrusting portion is defined at a free end portion of said first plate. Even more preferably, said second thrusting portion comprises a second swelling that extends towards said second plate.

Advantageously, the second swelling allows the second thrusting portion to come into contact with the chain in the last phases of upward gearshifting to position it on the toothed crown with a larger diameter, without the chain coming into contact with other portions of the first plate, an event that could make the action of the chain guide less effective and cause disturbing noises during gearshifting.

In a preferred embodiment of the invention, said second thrusting portion is integrally formed with said first plate.

In an alternative embodiment, said second thrusting portion is defined on an element removably associated with said first plate. In such a case, preferably, said first and second thrusting portions are defined on a single element removably associated with said first plate. However, an embodiment can be foreseen in which said first and second thrusting portions are defined on respective and distinct elements removably associated with said first plate.

Preferably, said first plate comprises a depressed plate portion between said first swelling and said second swelling. In the first plate a S-shaped profile is thus defined both in the vertical direction and in the longitudinal direction. During its displacement in upward gearshifting, the chain passes from the first swelling to the second swelling through the depressed plate portion.

Preferably, the first plate comprises at least one lightening aperture, which further contributes to the reduction in weight of the plate and therefore of the chain guide overall.

In a preferred embodiment, the first plate is made from a metal material, in order to ensure that it has sufficient structural strength and durability. Preferably, such a metal material comprises light metal alloys, such as aluminum alloys.

In an alternative embodiment, the first plate can be made from a composite material, like for example structural fibers incorporated in a matrix of polymeric material. The structural fibers can be selected from the group of carbon fibers, glass fibers, aramidic fibers, boron fibers and combinations thereof.

The second plate, being less stressed with respect to the first plate, is preferably made from a composite material, with advantages as to the overall weight of the chain guide. Preferably, the composite material comprises structural fibers such as glass fibers, carbon fibers, kevlar fibers and combinations thereof.

In an alternative embodiment, the second plate can also be made from a metal material. In such a case, the second plate is preferably integrally formed with the first plate, for example through successive steps of plastic deformation of a sheet.

According to a second aspect thereof, the invention refers to a front derailleur of a bicycle comprising a chain guide having the above outlined characteristics. Such a derailleur possesses all of the advantageous characteristics discussed above with reference to the chain guide of the invention.

According to a third aspect thereof, the present invention refers to a plate for the chain guide of a front derailleur of a bicycle comprising a first thrusting portion of a bicycle chain for shifting said chain from a first toothed crown with a diameter to a second toothed crown with a larger diameter, wherein said first thrusting portion is defined on a projection defined at a first portion of said plate and having a lower profile that projects with respect to the lower profile of the remaining portion of said plate. Such a plate is intended to be used in the chain guide of the present invention and allows therefore all of the advantageous characteristics discussed above with reference to the chain guide of the invention to be achieved.

### Description of the Embodiments

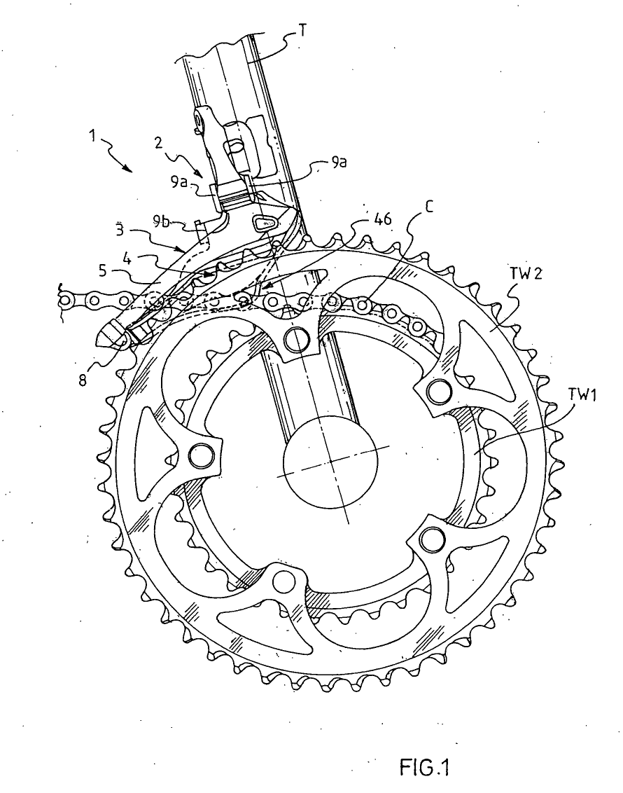

In the figures, a front derailleur of a bicycle (not shown in the figures) comprising a chain guide 3 according to the present invention is globally indicated with reference numeral 1. The front derailleur 1 essentially comprises an articulated quadrilateral positioning mechanism 2, of which the chain guide 3 constitutes one side. As shown in FIG. 1, the front derailleur 1 is fixed in a conventional way to a frame portion of the bicycle, usually a seat tube T (only partially visible in FIG. 1), in such a way that the chain guide 3 in its operating configuration lies above and close to a bottom bracket comprising a pack of toothed crowns (for example a pair of crowns TW1, TW2) and can act upon a chain C wound on one of such crowns.

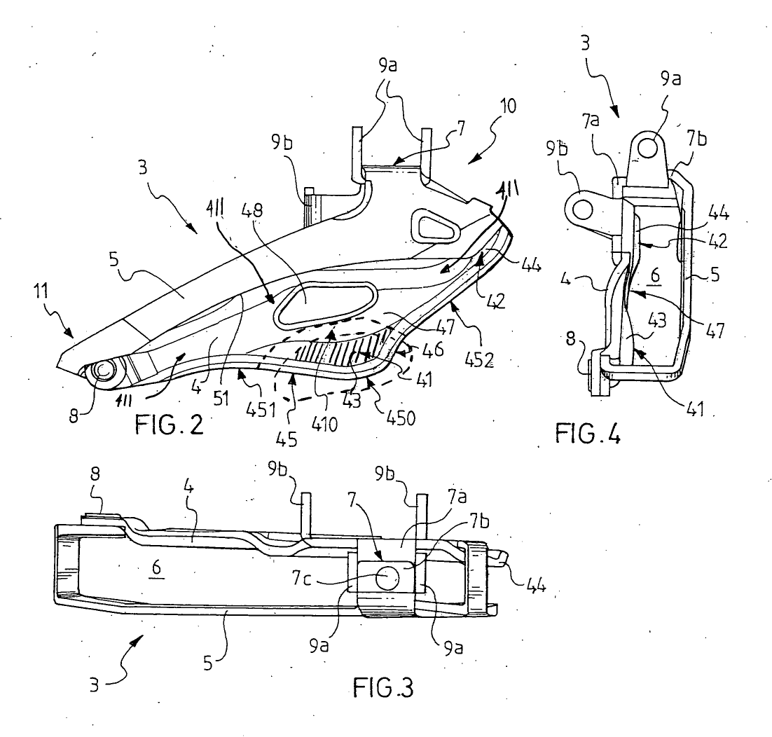

The chain guide 3 (see FIGS. 2-4) comprises a first plate 4, or inner plate, and a second plate 5, or outer plate, facing each other and substantially parallel, between which a space 6 is defined for the passage of the chain C.

The chain guide 3 further comprises, near to a first longitudinal end thereof 10, an upper connecting plate 7, preferably defined by two projections 7a, 7b integrally formed respectively with the inner plate 4 and the outer plate 5, at least partially overlapping and firmly connected together in a conventional way (for example through a pin 7c). At an opposite longitudinal end 11 further connecting means 8 of the two plates 4 and 5, for example screws, and in any case of the conventional type, are provided. The chain guide 3 is also provided with two pairs of projecting eyelets 9a, 9b, preferably formed integrally with the inner plate 4, which allow the chain guide 3 to be connected by a pin to the other elements of the positioning mechanism 2.

As can be seen in FIGS. 2-4 and in greater detail in FIGS. 5-9, the inner plate 4 comprises a first thrusting portion 41 (the boundary of this portion is shown as shaded in FIG. 2, although this boundary is approximate, and could be modified) and, in an upper position with respect to it and close to the longitudinal end 10, a second thrusting portion 42, at which the chain guide 3 thrusts the chain C during upward gearshifting, as better described hereafter.

The inner plate 4 has a lower profile or edge 45. According to the invention, the thrusting portion 41 is defined on a projection 46 (shown as bounded by a dashed ellipse in FIG. 2, although this boundary is approximate, and could be modified) defined at a first portion 410 of the inner plate 4. The first portion 410 is shown as roughly bounded by a dashed curved line in FIG. 2, which defines said first portion with respect to a remaining portion 411 of the first plate, although it should be understood that this boundary can be slightly different. The first portion 410 has a lower profile 450 projecting downwards with respect to the lower profile 451,452 of the remaining portion 411 (again with reference to the operating configuration shown in FIG. 1).

The projection 46 on which the thrusting portion 41 is defined is located in an intermediate position of the lower profile 45, preferably substantially equidistant from the longitudinal ends 10, 11 of the inner plate 4. In particular, the projection 46 extends longitudinally over a portion not larger than one third of the longitudinal size of the inner plate 4.

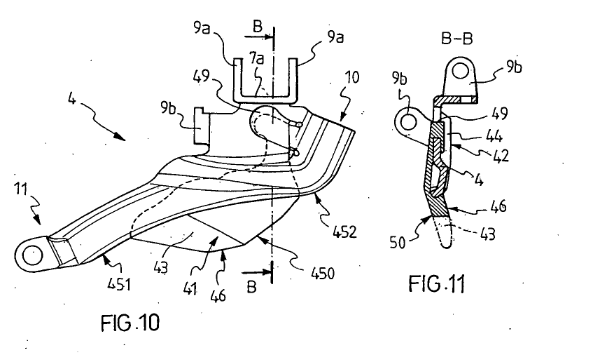

In a preferred embodiment of the invention, the projection 46 is integrally formed with the inner plate 4 on the plate portion 410 (FIGS. 2-9). In an alternative embodiment, shown in FIGS. 10 and 11, the projection 46 may constitute a portion of an element 50 distinct from the inner plate 4 and removably associated therewith in a conventional way, for example through coupling at a hole or aperture 49 formed on the inner plate 4 and at the lower profile thereof. The hole 49 is formed as a consequence of the realization of the projecting eyelet 9b, which is obtained by bending the edge of metal material which results from shearing the inner plate 4 with the desired eyelet shape.

The inner plate 4 further comprises a first swelling 43 and a second swelling 44 projecting towards the inside of the chain guide 3 and respectively defined at the first thrusting portion 41 and at the second thrusting portion 42. Between the swellings 43, 44 a depressed plate portion 47 is defined. In the preferred embodiment illustrated in the FIGS., the swellings 43, 44 are integrally formed with the inner plate 4; in alternative embodiments (not shown) one or both of them can be defined through additional plate-shaped elements removably associated with the inner plate 4.

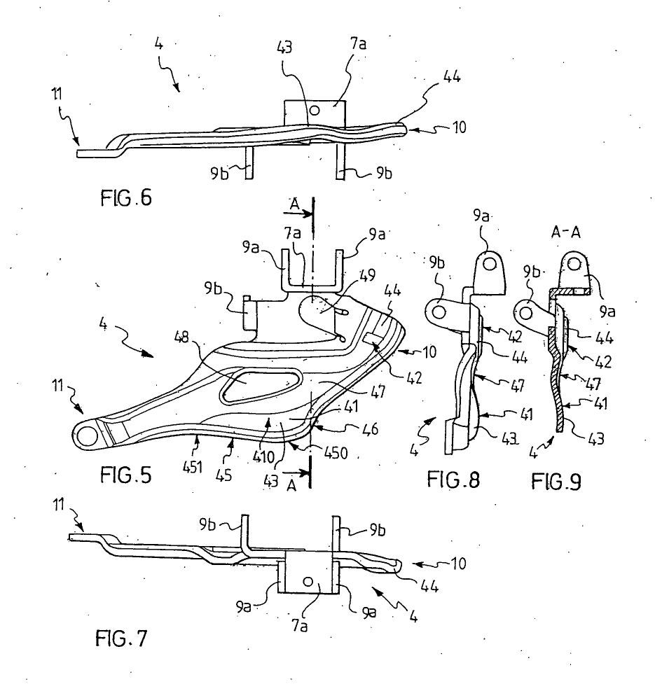

The swellings 43, 44 and the depression 47 globally give the inner plate 4 a substantially S-shaped progression both in the vertical direction, as can be seen in FIGS. 8 and 9, and in the longitudinal direction, as can be seen in FIGS. 6 and 7.

The inner plate 4 also comprises a lightening hole or aperture 48, preferably in a substantially central position.

The inner plate 4 is made from a light metal alloy, such as aluminum alloy, or alternatively from composite material, like for example from structural fibers incorporated in a matrix of polymeric material. The structural fibers can be selected from the group of carbon fibers, glass fibers, aramidic fibers, boron fibers and combinations thereof.

In the embodiments in which the projection 46 and/or the swellings 43,44 consists of elements associated with the inner plate 4, but distinct from it, such elements can be made from a material different to that of the plate 4, for example resins or resins loaded with structural fibers.

The outer plate 5, active in downward gearshifting as better described hereafter and substantially of the known type, has a lower profile 51 that is substantially semicircular and coaxial with respect to the toothed crowns TW1, TW2, and is made from a composite material comprising high-strength structural fibers, such as glass fibers, carbon fibers, kevlar fibers or combinations thereof. The second plate can, however, be made from a metal material and preferably integrally with the first plate, for example through successive steps of plastic deformation of a sheet.

During operation, the displacement of the chain guide 3 to carry out gearshifting is determined by a command given by the cyclist and transmitted to the positioning mechanism 2 of the derailleur 1 through a suitable actuator (not shown).

In the case of upward gearshifting, the chain guide 3 is displaced outwards and the inner plate 4 acts thrusting upon the chain C to shift it from the crown with a small diameter TW1 to the crown with a greater diameter TW2. More specifically, in a first step the first thrusting portion 41 with the first swelling 43 comes into contact with the chain C to thrust it against the front surface of the crown with a larger diameter TW2 and to start the displacement thereof upwards (such a situation corresponds to that which is represented in FIG. 1). In a subsequent step the chain C rises towards the toothed crown with a larger diameter TW2 following the substantially S-shaped profile of the inner plate 4, passing through the depression 47. In the final step of upward gearshifting, the chain C is thrust over the teeth of the crown with a larger diameter TW2 by the second thrusting portion 42 with the second swelling 44.

In the case of downward gearshifting the chain guide 3 is displaced inwards and the outer plate 5 acts thrusting upon the chain C to shift it from the crown with a larger diameter TW2 to the crown with a smaller diameter TW1. More specifically, the outer plate 5 comes into contact with the chain C and thrusts it towards the crown with a smaller diameter TW1. In the final step of downward gearshifting the chain C is guided over the teeth of the crown with a smaller diameter TW1 by the first swelling 43 at the first thrusting portion 41 of the inner plate 4; in this step such a first swelling 43 also allows the falling of the chain over the crown with a smaller diameter TW2 to be avoided.

A person of ordinary skill in the art may of course introduce modifications and variants to the preferred embodiments of the invention described above in order to satisfy specific and contingent operational requirements, such modifications and variants in any case falling within the scope of protection as defined by the subsequent claims.

1. A chain guide for a front derailleur of a bicycle, comprising:
a first plate for shifting a chain from a first toothed crown with a diameter to a second toothed crown with a larger diameter;
a second plate facing said first plate for shifting said chain from said second toothed crown to said first toothed crown; and
connecting means between said first plate and said second plate;
wherein said first plate comprises a first thrusting portion for shifting said chain from said first toothed crown to said second toothed crown, wherein said first thrusting portion is defined on a projection that is defined at a first portion of said first plate and has a lower profile that projects with respect to a lower profile of a remaining portion of said first plate.

2. The chain guide according to claim 1, wherein said projection is defined at an intermediate zone of said first plate.

3. The chain guide according to claim 2, wherein said projection is defined at a zone substantially equidistant from opposite first and second free end portions of said first plate.

4. The chain guide according to claim 1, wherein said projection extends in a longitudinal direction of the first plate over a portion of the first plate not larger than one third of a longitudinal size of said first plate.

5. The chain guide according to claim 1, wherein said projection comprises a first swelling that extends towards said second plate.

6. The chain guide according to claim 1, wherein said projection is integrally formed with said first plate.

7. The chain guide according to claim 1, wherein said projection is defined on an element removably associated with said first plate.

8. The chain guide according to claim 1, wherein said first plate comprises a second thrusting portion for shifting said chain from said first toothed crown to said second toothed crown, wherein said second thrusting portion is defined at a zone of said remaining portion arranged above said first portion.

9. The chain guide according to claim 8, wherein said second thrusting portion is defined at a free end portion of said first plate.

10. The chain guide according to claim 8, wherein said second thrusting portion comprises a second swelling that extends towards said second plate.

11. The chain guide according to claim 8, wherein said second thrusting portion is integrally formed with said first plate.

12. The chain guide according to claim 8, wherein said second thrusting portion is defined on an element removably associated with said first plate.

13. The chain guide according to claim 8, wherein said first and second thrusting portions are defined on a single element removably associated with said first plate.

14. The chain guide according to claim 8, wherein said first and second thrusting portions are defined on respective and different elements removably associated with said first plate.

15. The chain guide according to claim 10, wherein said first plate comprises a depressed plate portion between said first swelling and said second swelling.

16. The chain guide according to claim 1, wherein said first plate comprises at least one lightening aperture.

17. The chain guide according to claim 1, wherein said first plate is made from a metal material.

18. The chain guide according to claim 17, wherein said first plate is made from aluminum alloy.

19. A front derailleur of a bicycle, comprising a chain guide and an articulated quadrilateral mechanism that displaces said chain guide, wherein said chain guide is a chain guide according to claim 1.

20. A plate for a chain guide of a front derailleur of a bicycle, said plate comprising a first thrusting portion for thrusting a bicycle chain for shifting said chain from a first toothed crown with a diameter to a second toothed crown with a larger diameter, wherein said first thrusting portion is defined on a projection that is defined at a first portion of said plate and has a lower profile that projects with respect to the lower profile of a remaining portion of said plate.

21. A chain guide for a front derailleur of a bicycle, comprising:
a first plate for shifting a chain from a first toothed crown with a diameter to a second toothed crown with a larger diameter, the first plate comprising:
a first portion having a lower edge that projects below a lower edge of a remaining portion of said first plate, so as to define a projection;
a first thrusting portion located on the projection, the first thrusting portion contacting said chain during shifting from said first toothed crown to said second toothed crown;
a second plate facing said first plate for shifting said chain from said second toothed crown to said first toothed crown; and
a connection between said first plate and said second plate.

22. A chain guide for a front derailleur of a bicycle, comprising:
a first plate for shifting a chain from a first toothed crown with a diameter to a second toothed crown with a larger diameter, the first plate comprising:
a first portion having a lower edge that projects below a lower edge of a remaining portion of said first plate, so as to define a projection;
a first thrusting portion located on the projection, the first thrusting portion contacting said chain during shifting from said first toothed crown to said second toothed crown;
a second plate facing said first plate for shifting said chain from said second toothed crown to said first toothed crown; and
a connection between said first plate and said second plate;
wherein said projection comprises a first swelling that extends towards said second plate.

23. A chain guide for a front derailleur of a bicycle, comprising:
a first plate for shifting a chain from a first toothed crown with a diameter to a second toothed crown with a larger diameter, the first plate comprising:
a first portion having a lower edge that projects below a lower edge of a remaining portion of said first plate, so as to define a projection defined at an intermediate zone of said first plate;
a first thrusting portion located on the projection, the first thrusting portion contacting said chain during shifting from said first toothed crown to said second toothed crown;
a second plate facing said first plate for shifting said chain from said second toothed crown to said first toothed crown; and
a connection between said first plate and said second plate.

24. A chain guide for a front derailleur of a bicycle, comprising:
a first plate for shifting a chain from a first toothed crown with a diameter to a second toothed crown with a larger diameter, the first plate comprising:
a first thrusting portion located on a removable projection located on a first portion of said first plate, said removable projection having a lower edge that projects below a lower edge of a remaining portion of said first plate, the first thrusting portion contacting said chain during shifting from said first toothed crown to said second toothed crown;
a second plate facing said first plate for shifting said chain from said second toothed crown to said first toothed crown; and
a connection between said first plate and said second plate.

25. A chain guide for a front derailleur of a bicycle, comprising:
a first plate for shifting a chain from a first toothed crown with a diameter to a second toothed crown with a larger diameter, the first plate comprising:
a first portion having a lower edge that projects below a lower edge of a remaining portion of said first plate, so as to define a projection;
a first thrusting portion located on the projection, the first thrusting portion contacting said chain during shifting from said first toothed crown to said second toothed crown;
a second plate facing said first plate for shifting said chain from said second toothed crown to said first toothed crown; and
a connection between said first plate and said second plate;
wherein said first plate comprises a second thrusting portion for shifting said chain from said first toothed crown to said second toothed crown;
wherein said second thrusting portion is located on said remaining portion of said first plate.

26. A chain guide for a front derailleur of a bicycle, comprising:
a first plate for shifting a chain from a first toothed crown with a diameter to a second toothed crown with a larger diameter, the first plate comprising:
a first portion having a lower edge that projects below a lower edge of a remaining portion of said first plate, so as to define a projection;
a first thrusting portion located on the projection, the first thrusting portion contacting said chain during shifting from said first toothed crown to said second toothed crown;
a second plate facing said first plate for shifting said chain from said second toothed crown to said first toothed crown; and
a connection between said first plate and said second plate;
wherein said first plate comprises a second thrusting portion for shifting said chain from said first toothed crown to said second toothed crown;
wherein said second thrusting portion is located on said remaining portion of said first plate;
wherein said projection comprises a first swelling towards said second plate;
wherein said second thrusting portion comprises a second swelling that extends towards said second plate;
wherein said first plate comprises a depressed plate portion between said first swelling and said second swelling.

27. A chain guide for a front derailleur of a bicycle, comprising:
a first plate comprising:
a first portion having a lower edge that projects below a lower edge of a remaining portion of said first plate, so as to define a projection;
a first thrusting portion located on the projection, the first thrusting portion contacting a chain during shifting from a first toothed crown to a second toothed crown;
a second plate facing said first plate for shifting said chain from said second toothed crown to said first toothed crown; and
a connection between said first plate and said second plate;
wherein the first plate and the second plate lie in substantially parallel planes separated by the connection
